(19) United States
(12) Patent Application Publication
(10) Pub. No.: US 2014/0141722 A1
(43) Pub. Date: May 22, 2014

(54) DEVICE AND METHOD FOR RECEIVING AND PROCESSING DATA

(71) Applicant: Zuber Mohsan, Dubai (AE)

(72) Inventor: Zuber Mohsan, Dubai (AE)

(73) Assignee: SANDCASTLES INVESTMENT GROUP LIMITED, Dubai (AE)

(21) Appl. No.: 14/007,579

(22) PCT Filed: Mar. 15, 2012
(86) PCT No.: PCT/GB2012/050569

§ 371 Date: Feb. 4, 2014

(30) Foreign Application Priority Data
Mar. 25, 2011 (GB) 1105060.6

(51) Int. Cl. H04W 76/02

(52) U.S. Cl. CPC H04W 76/023; H04W 76/021
USPC 455/41.2

(57) ABSTRACT

A mobile telecommunication device is configured to receive data from a remote apparatus, process the data and (i) delete the data if the data has previously been received and stored by the device or (ii) store the data in the device. The device communicates with a remote server to access information associated with the apparatus and selectively process the information associated with the apparatus. The device is configured to operate independently of the apparatus to access information associated with the apparatus without a connection thereto.

### TECHNICAL FIELD

The invention relates to a mobile telecommunication device, such as a mobile phone, a method of operating the phone and a system to receive and selectively process information from such devices.

### BACKGROUND ART

Known devices, such as mobile phones, are configured to listen for wireless communication from other phones or devices within communicable range. Two or more devices can be connected, or paired, to enable data to be exchanged there between. By way of example, a link between two phones requires an initial set-up to enable data to be exchanged, and typically involves the sending of a request from a one device to another, which must be accepted by the other device before pairing can occur. Interaction, using a ‘handshake’ between the devices is required.

### SUMMARY OF THE INVENTION

An aspect of the invention resides in a mobile telecommunication device configured to: receive data from a remote apparatus; process the data and (i) delete the data if the data has previously been received and stored by the device or (ii) store the data in the device; communicate with a remote server to access information associated with the apparatus; and selectively process the information associated with the apparatus, wherein the device is configured to operate independently of the apparatus to access information associated with the apparatus without a connection thereto. The data received and stored by the device can be an identification tag, or identification data. The tag can be part of a Bluetooth™ transmission. The information associated with the apparatus, accessed from the remote server, is associated with, or derivable from, the data received by the device.

The device according to the invention can be said to be a target device, which is contacted by an initiating device. When the device is contacted it functions as a the target device. The device can. However, function as an initiating device and contact other devices. When contacted, it is the device (functioning as a target device) that selectively process the information associated with the apparatus, or initiating device, such that the device can manage or control the connection with the apparatus, either directly or via a remote sever. Similarly, the device can manage what information is shared.

The data processed can be stored in a temporary database in the device, such as a local memory component, or RAM. The device can filter the data processed. The device can selectively communicate with a remote server to access information associated with the apparatus, which had transmitted the data to the device. The filter can enable the device user to choose or select which further information is to be retrieved. By way of example, the user may want to receive information for users of a particular phone manufacturer, or of a particular sex. If the device user has indicated that further information is to be received then the device can automatically connect to a remote server, which can be any such remote resource, to receive information stored therein. To be clear, the filtering of the data received from the apparatus can occur on the device. The device can apply a filter and automatically decide, or allow a user to decide, whether to communicate with a remote server to access further information associated with the apparatus, which had transmitted the data to the device. The device can function to filter and decide which information about the apparatus to choose or select when requesting further information to be retrieved from a remote server.

The device can be configured to respond to information associated with the apparatus from which the data was acquired, received from a server, and selectively process the information to cause the device to respond in one or more or the following ways: (i) display the information associated with the apparatus from which the data was acquired; (ii) store the information associated with the apparatus from which the data was acquired on a main database in the device; (iii) provide a link that, when activated, enables the device to connect or access information or services associated with the remote apparatus; or (iv) enable the device to delete the information and/or inhibit device operation in response to data received from said apparatus.

The device can be configured to function as an apparatus and transmit an identification tag.

The device can be a Bluetooth™ enabled hand-held device that can automatically listen for other apparatus that can transmit a Bluetooth signal, such as another device. The device can search out a particular User ID within the Bluetooth signal and/or description.

Using the newly found ID the device can search a local database of identifications and based on certain criteria it can proceed to connect to a server, or data-store or similar remote resource and download data specific to that User ID and present it on the hand-held device.

Once the data is presented on the hand-held device the user can choose to delete the information or request further communication with the transmitting device in an Instant-messenger manner. Although the device and/or the apparatus are configurable to listen and transmit their identification information there is no connection required between the device and the apparatus, and no hand-shake or pairing required for either the device or apparatus to configure a data packet to be received or retrieve a data packet.

A second aspect of the invention resides in a method of operating a device, wherein the method comprises: receiving data from a remote apparatus; processing the data and (i) deleting the data if the data has previously been received and stored by the device or (ii) storing the data in the device; communicating with a remote server to access information associated with the apparatus; and selectively processing the information associated with the apparatus, wherein the device is configured to operate independently of the apparatus to access information associated with the apparatus without a connection thereto. The data received and stored by the device can be an identification tag, or identification data. The tag can be part of a Bluetooth™ transmission. The information associated with the apparatus, accessed from the remote server, is associated with, or derivable from, the data received by the device.

A third aspect of the invention resides in a system comprising the or each device and/or an apparatus as claimed.

A fourth aspect of the invention resides in a computer-readable medium having computer executable instructions configured to enable a computer to implement the or each method as claimed.

The invention generally resides in Bluetooth mobile phone devices that can be enabled to listen for other Bluetooth mobile phone devices, while at the same time it broadcasts its own Bluetooth ID (identification). While the recipient device is listening it can store any valid ID's formats into a local temporary database on its own internal memory or storage card. The device can check the local temporary database against the client setting against a predetermined or amendable criteria, such as gender. The client can set the criteria locally on the mobile phone device. If the gender check, gender differentiation, or other criteria, is compatible the ID can be sent to a main database to see if the ID is already listed (i.e. the ID has been previously received). If it is listed the ID is marked for deletion from temporary database.

After receiving a valid ID and checking that it does not already exist in the main database and the criteria is met the device can make an internet connection either via a local Wi-Fi network or the cellular network. Once the network link is in place the mobile phone device can send the ID's stored in the local temporary database to an internet File Server farm, or similar remote resource such as a data server. Upon receipt, the internet File Server Farm receives the ID from the mobile phone device and can select the data package, such as business card data, to be downloaded onto the mobile phone device. The data to be downloaded can be uploaded in advance by the owner of the ID approved for downloading to new contacts. The mobile phone device can receive the user data from the internet File Server Farm and display the new contact on the mobile phone device also saving it to the main mobile phone device database.

At the same time device can broadcast its ID to other devices and they are doing the same process. Note, however, that the or each device does not require pairing or similar two-way communications in order to retrieve the information from the remote resource.

A fifth aspect of the invention resides in a mobile telecommunication device, such as a mobile phone or personal data assistant, for receiving data from a remote apparatus comprising: processing means by which to process data; means to (i) delete the data if the data has previously been received and stored by the device or (ii) store the data in the device; means by which to communicate with a remote server to access information associated with the apparatus; and means to selectively process the information associated with the apparatus, wherein the device is configured to operate independently of the apparatus to access information associated with the apparatus without a connection thereto.

Differentiation, such as gender differentiation, and the means to differentiate, can be configured in the device such that no further information is sought about the apparatus if, for example, the apparatus user is a female who does not want to communicate with males. The differentiation can be configured in the device as described herein, or in the remote resource or server, or in the apparatus when the device chooses to communicate with it or the differentiation can reside in the or each component of the system. To be clear, differentiation, or the means to differentiate, can be configured to inhibit retrieval of information or sharing of information between device, apparatus and/or remote resource.

To be clear, where any aspect of the invention described herein relates to the device, or a component of the device, being ‘configured’ to implement a structure and/or function then said device or component can additionally or alternatively be provided with means that implement the corresponding structure and/or function and/or arrangement.

### BRIEF DESCRIPTION OF THE DRAWINGS

The invention will now be described in more detail with reference to the accompanying drawings wherein:

FIG. 1 shows system including a device and two apparatus in relation to a cloud and a remote server;

FIG. 2 shows an identification tag structure;

FIG. 3 is a table listing identification tag structures and the corresponding criteria associated with the tag; and

FIG. 4 shows the device of FIG. 1 having a number of components.

### DETAILED DESCRIPTION OF THE INVENTION

Set-up

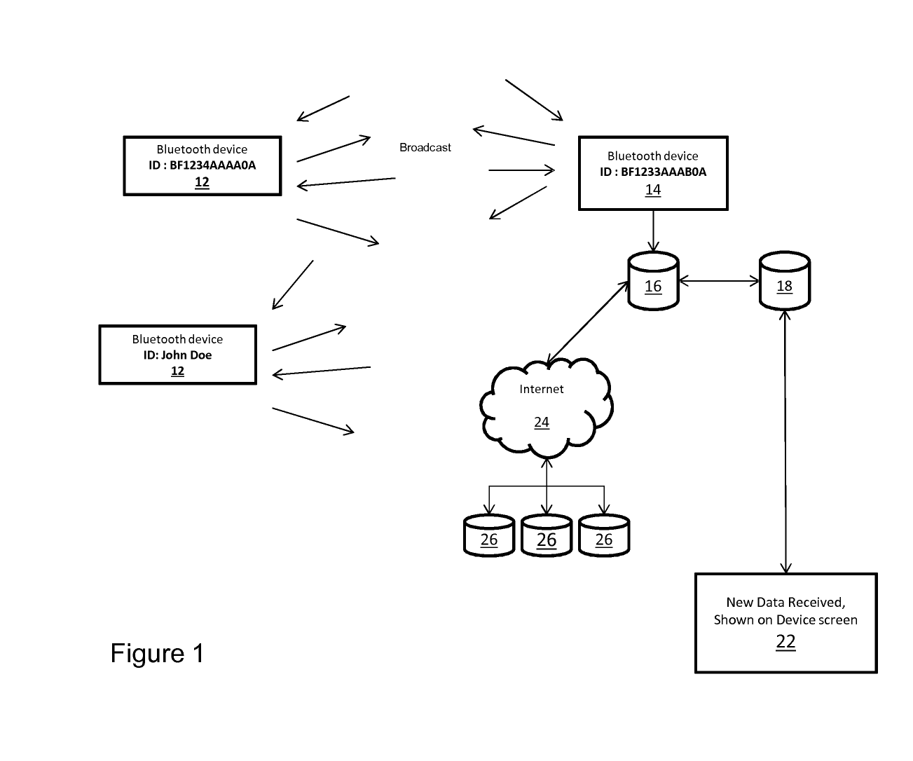

FIG. 1 shows a system 10 having one or more apparatus 12 in communication with a device 14. The device has a local database or store 16 and a main database or store 18. The device also has a filter 20 for selecting information from the or each store 16, 18. In the example configuration shown the filter 20 is connected to the local store 16. The filter 20 can be incorporated in one or more components of the device. The device also has a user interface, such as a display 22 for presenting and/or receiving information to a user of the device.

The system includes a connection 24, represented here by the ‘internet’ or cloud, which allows the device 14 to be connectable to a remote resource, such as a server 26 or remote database.

The apparatus 12 can transmit a signal that can be received by the device. The signal can be transmitted via a direct hard-wire link or via a wireless broadcast, such as a Bluetooth™ transmission.

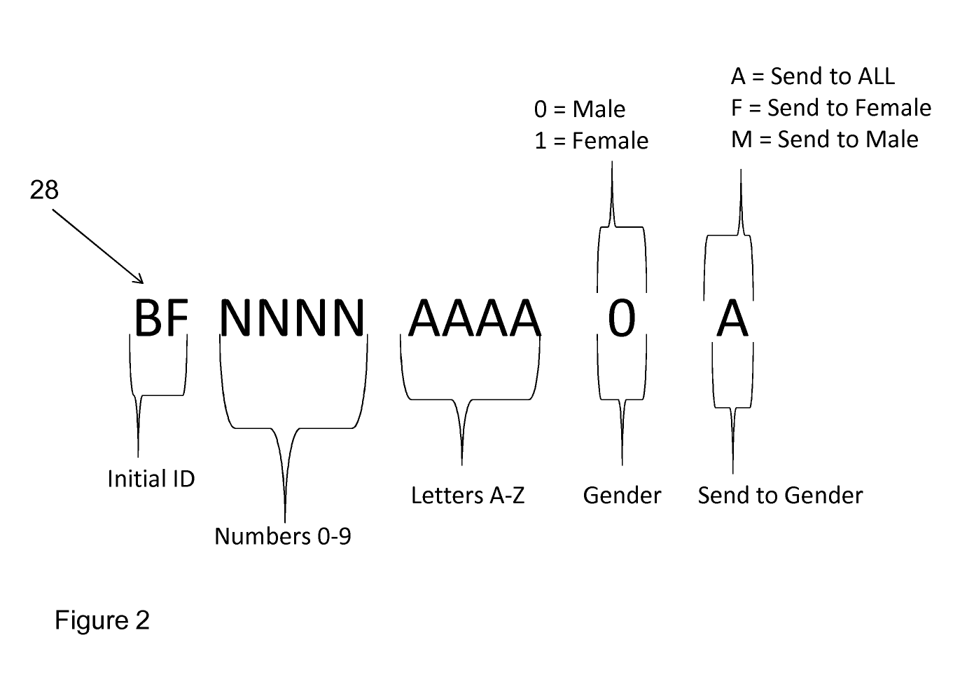

The signal comprises an identification tag 28 as shown in FIG. 2. The tag 28 incorporates one or more identifiers that enable the apparatus and/or the user to be identified therefrom. By way of example, the tag 28 has: a two-digit alphabetic code representing a general identification code, such a the device type; a four-digit numeric code, representing a unique user identification; a four-digit alphabetic code representing a group to which the user belongs; a gender indicator; and a reciprosity indicator, which enables a receipient of the signal to determine who the signal was intended for and whether the recipient would be able to initiate contact with the user of the apparatus.

The signal and/or the tag 28 can be used to identify the user of the apparatus and provides a means, such as a link or a key that enables a device receiving the tag to contact said user. By way of example, the receipient can establish contact in a conventional manner. Additionally, or alternatively, the user of the apparatus can, by way of example, pre-load information, contact details, marketing information and other such data that they want to be publically available to a store, such as a server. The tag 28 transmitted from the apparatus 12 to the device enables the user of the device that has received the tag to access the pre-loaded information.

The tag 28 can provide information that enables a user of the device 12 to access information, such as a packet of information intended for a recipient of the tag, which includes Twitter™, Facebook™, business details, promotional information, discount codes and the like.

Connection

The device 14 can access information associated with the apparatus 12 from the signal and/or tag 28 without connecting with the apparatus 12 or pairing with the device. The device 12 can function, review and respond to the signal independently of the apparatus. The user of the apparatus provides the tag, which functions as a key, so that the recipient can access pre-determined information associated with the key, such as pre-loaded information and/or a data packet, without two-way communication or pairing being established.

Device Operation

The structure and operation of the device can be described, by way of example, using the following scenario at a trade-show, wherein a user of an apparatus 12 can pre-load information about the user, such as a business card and contact details to a server for access by a device. The apparatus 12 transmits the tag 28 for receipt by a device, such that the device can use the tag to access the pre-loaded data.

A device 14, linked to, or in communicable range of the apparatus 12 detects the signal 28, receives the tag and stores the data in the local store 16, which is typically a temporary memory unit within the device.

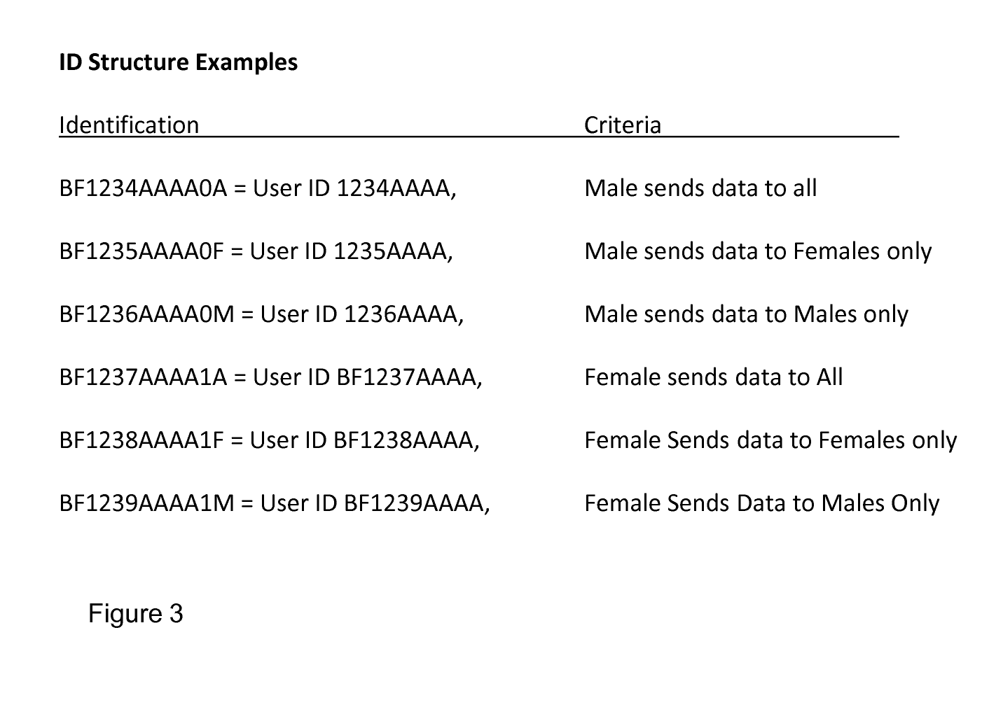

The tag can indicate a particular characteristic of an apparatus user, for example, the sex of the person and whether they wish to provide information to everyone, only females or only males. FIG. 3 is a table listing the criteria that a tag 28 can indicate who the the data or information is intended for, by way of the last two digits, which includes: “0A”—males sends data to all; “0F”—male sends data to females only; “0M”—male sends data to males only; “1A”—female sends data to all; “1F”—female sends data to females only; and “1M”—female sends data to males only. Other criteria can be applied.

In this example, the reciprocity indicator, i.e. “0M” is used to enable the device 14 to determine, using the filter 20, whether the apparatus user wants the recipient to contact the apparatus user. Thus the tag 28 and the filter 20 enable the device 14 to determine who the signal was intended for and whether the device 14 user would be able to initiate contact with the user of the apparatus 12.

If the device 14 user is an intended recipient of the signal, or the user has indicated that they want to access further information, then the filter 20 enables the tag 28 and associated information to be stored in the main store 18. If the tag has previously been received the tag is deleted from the local store 16 and the user is presented with a pre-determined set of actions or responses, as described below, via the display 22. If the tag has been received before then the device can indicate on the display one of the previous time the data was received, the number of times and one or more other statistical facts associated with the tag. The device can also indicate whether the tag was previously ignored.

When a new tag 28 is stored in the main store 18, the device establishes a connection with the remote server 26 that contains pre-loaded information associated with the signal 28. The connection can be via an internet connection via a Wi-Fi network or cellular network. Once a connection is made, the device 14 sends the tag 28 and receives pre-loaded information associated with the apparatus 12. The information or data can be downloaded and saved in the device.

The device 14 can process the information associated with the apparatus and present the user of the device with a number of options via the display 22. These options include: displaying the information associated with the apparatus 12 that was retrieved from the server 26, which may be a business card, business profile or personal profile; asking the user whether they want to store the information received for use at a later date; providing a link that, when activated, enables the device 14 to connect or access information or services associated with the apparatus 14, which can involve the device 14 making a conventional telephone call to the apparatus 12 or sending a text-message directly to the apparatus; or presenting the user of the device 14 the option to delete the information and/or inhibit device operation in response to data received from said apparatus 14. The device can also be configured to receive and auto-fill a form using personal data on the device to enable the device user to access further data or services more quickly.

Note that these options can also be presented to a device user when the tag has been received previously. The device can recall the information associated with a tag or access a server to establish if updated information is available, and if so then access and update the device so that the device user has the latest information.

The device 14 can be configured like the apparatus 12 and transmit a signal having a tag 28. The apparatus 12 can have the same features and functionality as the device 14.

The device and/or apparatus and/or remote resource can be configured with a reciprocity component that functions as a means to differentiate and allow or inhibit the retrieval of information according to a predetermined differentiation criteria.

Feature

One of the main characteristics of the device 14 and/or the system 10 is that the recipient of a signal 28 coming from an apparatus 12 can access pre-loaded information prepared by the apparatus user without a connection or pairing of the apparatus 12 with the device 14. In other words, the tag 28 enables the user to remain hidden and access independently information about the apparatus. Moreover, the device 14 can selectively filter and store received tags according to a flag, or indicator within a tag 28.

Further Example

Although the above example involves the exchange of business card information between an apparatus 12 and a device 12, the apparatus can be a standalone device configured to transmit a signal and tag 28 that enable a user to access discount codes or promotional offers or information via the device 12. The device can additionally or alternatively access one or more documents such as a web-page link, a promotional document.

The data that the device receives from the server can be provided according to the language configurations of the device, such that a device is use by an English person, using English, can receive an English language version of a data packet if on a business trip in China.

By way of example, an apparatus can transmit a signal and tag 28 in a supermarket. A device 14 can receive the signal and selectively filter the signals from the apparatus. If the signal passes the filter because the user wants or permits to receive an offer, the device can retrieve the offer information, pre-loaded by the apparatus, and present the details to the device 14 user via the display 22. The information can be, for example, in the form of a bar-code that can be used at the checkout, or can be a link that enables a user to print a voucher in a conventional manner.

Hardware

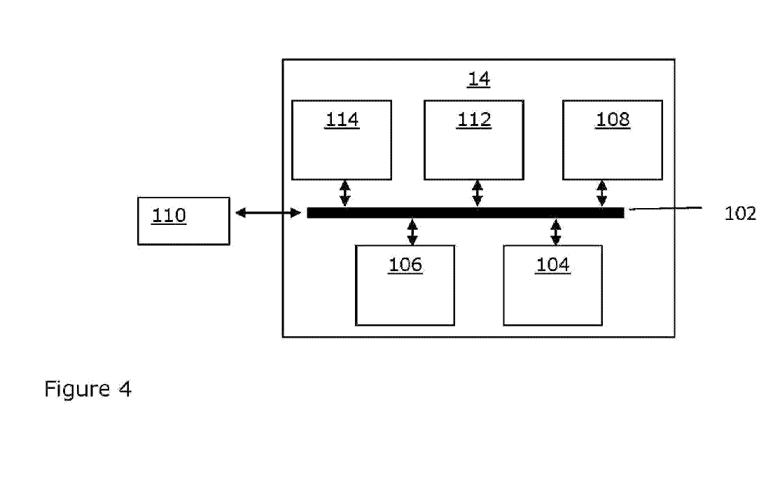

FIG. 4 is a system diagram of a device 14 upon which the invention can be implemented and the general method described herein can be implemented using, at least in part, software operating on a computer system. By way of example, the device 14 can have the components in FIG. 1, which is an example of a computer system having a device 100. The device 100 includes a bus 102, at least one processor 104, at least one communication port 106, a main memory 108, a removable storage media 110, a read only memory 112 and a random access memory 114. The components of device 100 can be configured across two or more devices, or the components can reside in a single device 14.

The processor 104 can be any such device such as an Intel® or AMD® processor. The port 106 can be an RS-232 connection, or a Bluetooth connection or any such wireless connection. The port can be configured to communicate on a network such a Local Area Network (LAN), Wide Area Network (WAN), or any network to which the device 100 connects. The read only memory 112 can store instructions for the processor 104.

The bus 102 communicably couples the processor 104 with the other memory 110, 112, 114, 108 and port 106. The bus can be a PCI /PCI-X or SCSI based system bus depending on the storage devices used, for example. The removable storage 110 can be any kind of external hard-drives, floppy drives, flash drives, for example. The device and components therein is provided by way of example and does not limit the scope of the invention.

The processor 104 can implement the methods described herein. In particular, the processor 104 can retrieve and/or receive event 10 information from a remote server 26. The server can be a remote resource and the bus 102 can connect to the server 22 via the internet, for example. Additionally or alternatively, the processor 104 accesses the server via the port 106.

The device 100 is operated by the method to receive a signal having a tag 28 and retrieve and/or store information from the remote resource 26.

The present invention has been described above purely by way of example, and modifications can be made within the spirit and scope of the invention, which extends to equivalents of the features described and combinations of one or more features described herein. The invention also consists in any individual features described or implicit herein or shown or implicit in the drawings or any combination of any such features or any generalisation of any such features or combination.

1. A mobile telecommunication device configured to:
receive data from a remote apparatus;
process the data and (i) delete the data if the data has previously been received and stored by the device or (ii) store the data in the device;
communicate with a remote server to access information associated with the apparatus; and
selectively process the information associated with the apparatus,
wherein the device is configured to operate independently of the apparatus to access information associated with the apparatus without a connection thereto.

2. A device according to claim 1, wherein the data received and stored by the device is an identification tag.

3. A device according to claim 1, wherein the data processed is stored in a temporary database in the device.

4. A device according to claim 1, wherein the device filters the data processed and selectively communicates with a remote server to access information associated with the apparatus.

5. A device according to claim 1, wherein the device is configured to respond to information associated with the apparatus from which the data was acquired, received from a server, and selectively process the information to cause the device to respond in one or more or the following ways:
(i) display the information associated with the apparatus from which the data was acquired;
(ii) store the information associated with the apparatus from which the data was acquired on a main database in the device;
(iii) provide a link that, when activated, enables the device to connect or access information or services associated with the remote apparatus; or
(iv) enable the device to delete the information and/or inhibit device operation in response to data received from said apparatus.

6. A device according to claim 1, wherein the device is configured to function as an apparatus and transmit an identification tag.

7. A method of operating a device, wherein the method comprises:
receiving data from a remote apparatus;
processing the data and (i) deleting the data if the data has previously been received and stored by the device or (ii) storing the data in the device;
communicating with a remote server to access information associated with the apparatus; and
selectively processing the information associated with the apparatus,
wherein the device is configured to operate independently of the apparatus to access information associated with the apparatus without a connection thereto.

8. A method according to claim 7, further comprising storing the data processed in a temporary database in the device.

9. A method according to claim 7, further comprising filtering the data processed and selectively communicating with a remote server to access information associated with the apparatus.

10. A method according to claim 7, further comprising connecting the device to a remote server, providing the data thereto, and requesting the information associated with the apparatus from which the data was acquired.

11. A method according to claim 7, further comprising responding to information associated with the apparatus from which the data was acquired, received from a server, and selectively processing the information to cause the device to respond in one or more or the following ways:
(i) display the information associated with the apparatus from which the data was acquired;
(ii) store the information associated with the apparatus from which the data was acquired on a main database in the device;
(iii) provide a link that, when activated, enables the device to connect or access information or services associated with the remote apparatus; or
(iv) enable the device to delete the information and/or inhibit device operation in response to data received from said apparatus.

12. A method according to claim 7, further comprising transmitting an identification tag.

13. A system comprising the device according to claim 7.

14. (canceled)

15. A mobile telecommunication device, such as a mobile phone or personal data assistant, for receiving data from a remote apparatus comprising:
processing means by which to process data;
means to (i) delete the data if the data has previously been received and stored by the device or (ii) store the data in the device;
means by which to communicate with a remote server to access information associated with the apparatus; and
means to selectively process the information associated with the apparatus,
wherein the device is configured to operate independently of the apparatus to access information associated with the apparatus without a connection thereto.
